(19) United States
(12) Patent Application Publication
(10) Pub. No.: US 2022/0036738 A1
(43) Pub. Date: Feb. 3, 2022

(54) METHOD AND SYSTEM FOR ASSESSING AND EARLY WARNING SHIP COLLISION RISK

(71) Applicant: Wuhan University of Technology, Hubei (CN)

(72) Inventors: Jingxian LIU, HUBEI (CN); Wen LIU, HUBEI (CN); Kai WANG, HUBEI (CN); Zhao LIU, HUBEI (CN)

(21) Appl. No.: 17/032,629

(22) Filed: Sep. 25, 2020

(30) Foreign Application Priority Data
Jul. 29, 2020 (CN) 202010747161.2

(51) Int. Cl. G08G 3/02; G01C 21/20; G06K 9/62; G01W 1/10

(52) U.S. Cl. CPC G08G 3/02; G01W 1/10; G06K 9/6256; G01C 21/203

(57) ABSTRACT

The present application discloses a method and a system for assessing and early warning ship collision risk, an electronic device, and a computer-readable storage medium. The method includes: acquiring hydrological information and meteorological information of a current position of a designated ship, and acquiring navigation information of the designated ship and other ships; acquiring real-time collision risk of the designated ship through evaluation of a trained adaptive collision risk assessment model; determining a risk level of the designated ship according to the real-time collision risk; and outputting an early warning message associated with the risk level to the designated ship. This solution constructs an adaptive collision risk assessment model, and evaluates the ship collision risk by combining regional historical information and current navigation information, which can improve assessment accuracy of the ship collision risk and timeliness of early warning.

### CROSS REFERENCE TO RELATED APPLICATIONS

This application claims priority to Chinese Patent Application No. 202010747161.2 filed on Jul. 29, 2020, the content of which is incorporated herein by reference thereto.

### TECHNICAL FIELD

The present application relates to the field of intelligent transportation systems for water traffic, and particularly to a method for assessing and early warning ship collision risk, a system for assessing and early warning ship collision risk, an electronic device, and a computer-readable storage medium.

### BACKGROUND

With the unstoppable trend of economic globalization, the shipping industry has rapidly developed worldwide. A large number of ships have been invested in water transportation to meet transport needs, thus there is heavier traffic and increasing crowd within the waterway areas. Consequently, conflicts between ships have become more frequent, and marine accidents have occurred from time to time.

The combination of real-time navigation risk and historical conflict risks of navigation is the current development trend of safe navigation for ships. Regarding the combination of historical navigation risks, some port of water areas have currently established official precautionary areas based on the spatial distribution characteristics of marine accidents to remind the deck officers of ships navigating in these areas, which are similar to warnings at accident-prone sections in road traffic. However, there are relatively few water traffic accidents, which cannot provide a large amount of data basis for the establishment of official precautionary areas, and thus there is no enough sufficient theoretical support.

At present, the traditional collision risk calculation method is mainly based on ship-borne radar to grasp real-time dynamic information of other ships, but the ship-borne radar still has defects of being vulnerable to external environments and low recognition accuracy. In order to better quantify a potential risk of conflicts between ships, the DCPA (Distance at Closest Point of Approach) and the TCPA (Time to Closest Point of Approach) have been widely used, and calculating the TCPA and the DCPA can provide a reference basis for ship collision. The mandatory use of a ship-borne MS (Automatic Identification System) provides a massive data basis for ship risk measurement, which greatly improves the navigational safety for ships. However, in actual navigational situations, the ship collision risk is also affected by external factors, such as wind, flow, visibility, etc. Current risk measurement models fail to fully consider these influencing factors, and therefore cannot accurately reflect the risk level of the ship collision. This poses a severe challenge to existing risk assessment and early warning for the marine traffic safety and security.

### SUMMARY

The present application provides a method for assessing and early warning ship collision risk, a system for assessing and early warning ship collision risk, an electronic device, and a computer-readable storage medium. By constructing an adaptive collision risk assessment model, the ship collision risk is assessed by combining historical navigation information and current navigation information when the ship is navigating underway, which can improve the assessment accuracy for the ship collision risk and the timeliness of early warning.

A first aspect of the present application provides a method for assessing and early warning ship collision risk, which includes:

acquiring hydrological information and meteorological information of a position where a designated ship is located, and acquiring navigation information of the designated ship and other ships, here the navigation information includes navigation speeds, navigation directions, and positions;

acquiring real-time collision risk of the designated ship through evaluation of a trained adaptive collision risk assessment model based on the hydrological information, the meteorological information and the navigation information, here the adaptive collision risk assessment model is constructed according to a preset near-miss collision database and a water area where the designated ship is located, the near-miss collision database comprises at least one pair of navigation trajectories, and the minimum relative distance of two navigation trajectories in each pair of navigation trajectories is less than a preset threshold;

determining a risk level of the designated ship according to the real-time collision risk;

outputting an early warning message associated with the risk level to the designated ship.

A second aspect of the present application provides a system for assessing and early warning of ship collision risk, which includes:

an acquisition unit, configured to acquire hydrological information and meteorological information of a position where a designated ship is located, and acquire navigation information of the designated ship and other ships, here the navigation information includes navigation speeds, navigation directions, and positions;

an evaluation unit, configured to acquire real-time collision risk of the designated ship through evaluation of a trained adaptive collision risk assessment model based on the hydrological information, the meteorological information and the navigation information, here the adaptive collision risk assessment model is constructed according to a preset near-miss collision database and a water area where the designated ship is located, the near-miss collision database comprises at least one pair of navigation trajectories, and the minimum relative distance of two navigation trajectories in each pair of navigation trajectories is less than a preset threshold;

a determination unit, configured to determine a risk level of the designated ship according to the real-time collision risk;

an output unit, configured to output an early warning message associated with the risk level to the designated ship.

A third aspect of the present application provides an electronic device which includes a memory, a processor and a computer program stored in the memory and capable of being executed on the processor, the processor, when executing the computer program, implements the steps of the method of the first aspect.

A fourth aspect of the present application provides a computer-readable storage medium in which a computer program is stored, the computer program, when executed by a processor, implements the steps of the method of the first aspect.

A fifth aspect of the present application provides a computer program product which includes a computer program, the computer program, when executed by one or more processors, implements the steps of the method of the first aspect.

It can be seen from the above that, when constructing the adaptive collision risk assessment model according to the preset near-miss collision database and the water area where the designated ship is located in the embodiments of the present application, the adaptive collision risk assessment model can fully learn the various historical data stored in the near-miss collision database. When the adaptive collision risk assessment model is applied, the hydrological information, meteorological information and navigation information associated with the designated ship are all served as the input data of the adaptive collision risk assessment model, which not only considers the impact of other ships on the designated ship, but also takes into account the impact of environmental factors on the designated ship, so as to improve the assessment accuracy of ship collision risk. Moreover, the early warning message is output according to the risk level corresponding to the collision risk, thereby reducing the possibility of ship collision. It should be understood that, the beneficial effects of the second aspect, the third aspect, the fourth aspect and the fifth aspect may refer to related description for the first aspect described above, and details are not repeated herein.

### DESCRIPTION OF THE DRAWINGS

In order to describe the technical solutions in the embodiments of the present application more clearly, the drawings used in the description of the embodiments or the prior art will be briefly introduced below. Obviously, the drawings in the following description are only some embodiments of the present application, and other drawings may be obtained by those of ordinary skill in the art without creative work based on these drawings.

FIG. 1 is a schematic diagram of the implementation process of the method for assessing and early warning ship collision risk provided by an embodiment of the present application.

FIG. 2 is a schematic diagram of a ship navigating within a water area provided by an embodiment of the present application.

FIG. 3 is a schematic diagram of a construction process of a near-miss collision database provided by an embodiment of the present application.

FIG. 4 is a schematic diagram of a construction process of an adaptive collision risk assessment model provided by an embodiment of the present application.

FIG. 5 is a schematic diagram of an implementation process of acquiring historical grid conflict risk in the method for assessing and early warning ship collision risk provided by an embodiment of the present application.

FIG. 6 is a schematic diagram of indicating a water area where a designated ship is located according to an embodiment of the application.

FIG. 7 is a schematic diagram of a user interface displayed on a display screen of a ship-borne device provided by an embodiment of the present application.

FIG. 8 is a schematic diagram of a scenario when the execution subject is a different electronic device according to an embodiment of the present application.

FIG. 9 is a structural block diagram of the system for assessing and early warning ship collision risk provided by an embodiment of the application.

FIG. 10 is a schematic structural diagram of the electronic device provided by an embodiment of the present application.

### DETAILED EMBODIMENTS

In the following description, for the purpose of illustration rather than limitation, specific details such as a specific system structure and a specific technology are proposed for a thorough understanding of the embodiments of the present application. However, it should be understood to those skilled in the art that the present application can also be implemented in other embodiments without these specific details. In other cases, detailed descriptions of well-known systems, devices, circuits, and methods are omitted to avoid unnecessary details from interfering the description of the present application.

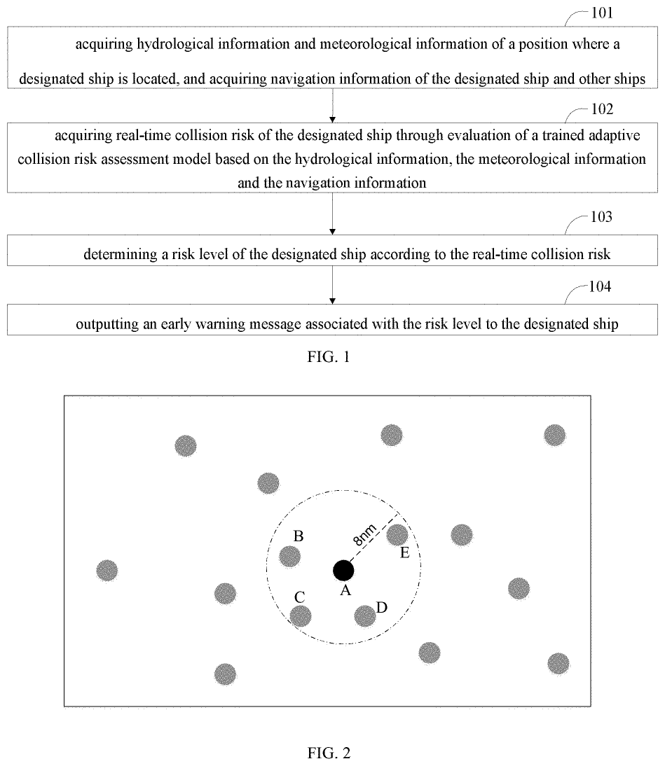

The following describes the method for assessing and early warning ship collision risk provided by an embodiment of the present application. Referring to FIG. 1, the method for assessing and early warning ship collision risk in the embodiment of the present application includes the following.

At step 101, acquire hydrological information and meteorological information of a location of a designated ship, and acquire navigation information of the designated ship and other ships.

In an embodiment of the present application, the ship that needs to assess its navigation risk may be determined as the designated ship so as to perform each step of the embodiment of the present application. After the designated ship is determined, on the one hand the hydrological information and meteorological information of the location of the designated ship may be acquired, and on the other hand the navigation information of the designated ship and other ships may be acquired.

Among them, the hydrological information and meteorological information of the designated ship may be collected through a sensor device mounted on a top deck of the designated ship; alternatively, it may be acquired by receiving information issued by an official department. The method of acquiring the hydrological information and meteorological information is not limited herein. Among them, the hydrological information includes but is not limited to flow rate, flow direction and wave height, etc.; the meteorological information includes but is not limited to wind speed, wind direction and visibility, etc.

Among them, the above-mentioned navigation information includes navigation speeds, navigation directions and positions of the designated ship and other ships. Later, a relative navigation speed, a relative navigation direction and a relative distance between the designated ship and each of the other ships may be calculated via the navigation speeds, navigation directions and positions of the designated ship and other ships, and the relative navigation speed, relative navigation direction and relative distance between the designated ship and each of other ships may be used as input data of an adaptive collision risk assessment model. The above-mentioned other ships specifically refer to ships within a preset range (for example, within 8 nautical miles) of the designated ship. Exemplarily, each ship may acquire its own position, navigation speed, and navigation direction through a GPS (Global Positioning System), subsequently each ship can send its own position, navigation speed, and navigation direction to other ships within the preset range through the AIS. In this way, the designated ship can receive the positions, navigation speeds, and navigation directions of other ships. It should be noted that when each ship sends its own position, navigation speed, and navigation direction to other ships within the preset range through the AIS, it will be accompanied by a unique identification code, such as MMSI (Maritime Mobile Service Identify), used to indicate which ship the information being sent is sent from to avoid confusion. Of course, the ships may also send other information through the AIS, for example, types of the ships may also be sent, which is not limited herein.

At step 102: acquire real-time collision risk of the designated ship through assessment of the trained adaptive collision risk assessment model, based on the hydrological information, the meteorological information, and the navigation information.

In an embodiment of the present application, the adaptive collision risk assessment model is constructed according to a preset near-miss collision database and a water area where the designated ship is located. Among them, the near-miss collision database includes at least one pair of navigation trajectories, and the minimum relative distance between two navigation trajectories in each pair of navigation trajectories is less than a preset threshold.

For this adaptive collision risk assessment model, the real-time collision risk of the designated ship relative to any one of other ships may be acquired once the hydrological information, meteorological information of the designated ship and the navigation information of the designated ship and any one of other ships are input.

For example, within the preset range of the designated ship A, there are a ship B and a ship C. The hydrological information A1 and meteorological information A2 of the designated ship A, the navigation information A3 of the ship A, the navigation information A4 of the ship B and the navigation information A5 of the ship C may be acquired. The real-time collision risk R1 of the ship A relative to the ship B may be acquired via the hydrological information A1, the meteorological information A2, the navigation information A3 of the ship A and the navigation information A4 of the ship B, and at the same time the real-time collision risk R2 of the ship A relative to the ship C may be acquired via the hydrological information A1, the meteorological information A2, the navigation information A3 of the ship A and the navigation information A5 of the ship C. That is, since there are two other ships within its preset range, two real-time collision risks will be calculated for the ship A.

In other words, the trained adaptive collision risk assessment model actually outputs the real-time collision risks of the designated ship relative to each of the other ships, and sorts the collision risks relative to each of the other ships in a descending order, and outputs the sorted collision risks to a deck officer of the designated ship, so that the deck officer can take a measure to preferentially avoid collision with ships bringing in correspondingly high risks based on real-time collision risk levels.

Please refer to FIG. 2. FIG. 2 shows a schematic view of a ship navigating in a certain water area, in which each solid dot indicates one ship, and a vicinity of each ship is delimited with each ship as the center and a preset distance (8 nautical miles) as the radius. For the ship A, there are ships B, C, D and E within its preset distance; the real-time collision risk R_{AB} between the ship A and the ship B, the real-time collision risk R_{AC} between the ship A and the ship C, the real-time collision risk R_{AD} between the ship A and the ship D, and the real-time collision risk R_{AE} between the ship A and the ship E may be acquired through the trained adaptive collision risk assessment model. Assuming that R_{AB}<R_{AD}<R_{AC}<R_{AE}, then the deck officer of the ship A can preferentially take a measure to the ships bringing in correspondingly high risks after learning the real-time collision risk sort between the designated ship and nearby ships.

At step 103, determine a risk level of the designated ship according to the real-time collision risk.

In an embodiment of the present application, the risk level of the designated ship may be determined according to the real-time collision risk of the designated ship. Exemplarily, a plurality of real-time collision risk intervals may be preset, and each of the real-time collision risk intervals corresponds to a different risk level, then the current risk level of the designated ship may be determined according to the real-time collision risk interval that the real-time collision risk falls into.

In some embodiments, if there are more than two other ships within the preset range of the designated ship, then at the step 102 the real-time collision risk of the designated ship relative to each of the other ships will be acquired. At this time, it can be first determined whether the maximum value of the real-time collision risks acquired is greater than a preset risk threshold. If the maximum value is less than or equal to the risk threshold, the designated ship is considered to be correspondingly safe at present and has a correspondingly low probability to collide with other ships, thus there is no need to remind the deck officer of potential collision risk, that is, the risk level at this moment is at low risk level. On the contrary, if the maximum value is greater than the risk threshold, it is considered that the designated ship may possibly collide with other ships, and the deck officer needs to be reminded at this time. Exemplarily, in this case, the risk level of each real-time collision risk may be determined separately, and the risk levels are accumulated to acquire a final risk level of the designated ship, and both the risk level of each real-time collision risk and the final risk level are output to the designated ship, thereby realizing early warning to the deck officer of the designated ship.

At step 104, output an early warning message associated with the risk level to the designated ship.

In an embodiment of the present application, the early warning message associated with the risk level may be output to the designated ship through a ship-borne terminal of the designated ship. Herein, the early warning message may adopt many forms, including but not limited to a visual reminder, an auditory reminder, or other reminder forms that can attract the attention of the deck officer. In order to avoid distracting the attention of the deck officer as much as possible, the early warning message may be preferably output in a form of a non-visual reminder.

Of course, it is also possible to set the associated early warning message only for the medium risk level or the high risk level. For the low risk level, there is no need to output the early warning message. In addition, a collision avoidance recommendation may be given when outputting the early warning message. Under normal circumstances, when receiving the early warning message, the deck officer will determine an encounter situation of the ship, and take a reasonable measure to avoid occurrence of ship collision according to the collision avoidance recommendation, specifically the operation depends on the specific situation, such as changing the navigation direction, reducing the navigation speed or a combination of the two, etc. When the risk level of the designated ship is reduced to a low risk level, the deck officer of the designated ship may be reminded that the potential collision risk has disappeared, so that the deck officer can resume normal operations and return to the scheduled route.

In some embodiments, if there are more than two other ships within the preset range of the designated ship, the early warning message associated with the final risk level may be output to the designated ship after the risk level bringing in by each of other ships and the final risk level are acquired. Alternatively, after outputting the early warning message associated with the final risk level to the designated ship, and then the early warning messages associated with the risk levels of other ships may be output in sequence in the descending order of the risk levels. The early warning strategy can be specifically set by the deck officer of the designated ship according to personal preference, and there is no limitation herein.

Considering that the adaptive collision risk assessment model is constructed based on the preset near-miss collision database, in order to better understand the embodiments of the present application, the near-miss collision database is explained and described hereafter. Please refer to FIG. 3. FIG. 3 shows the construction process of the near-miss collision database, which includes the following.

At step 301, perform data cleaning and sorting on navigation trajectories within a designated water area to acquire at least one pair of navigation trajectories;

In an embodiment of the present application, when constructing the near-miss collision database, a water area may be selected as the designated water area first, and the ships navigating within the designated water area may be monitored during a period of time (for example, one month). For any ship navigating within the designated water areas, on the one hand, the positions, navigation directions and navigation speeds of the ships may be monitored to acquire the ships' navigation information, on the other hand, the hydrological information and meteorological information at each moment may also be monitored when the ship navigates. Then data cleaning is performed for each navigation trajectory within the designated water area, such as noise filtering, etc., to remove invalid or illegal trajectory points in the navigation trajectory. Afterwards, the acquired navigation trajectories are sorted according to their starting times:

∀i∈{1,2, . . . }:tₛₜₐᵣₜ^{traj,i}≤tₛₜₐᵣₜ^{traj,i+1}

When the starting time of one navigation trajectory is earlier than the ending time of another navigation trajectory, that is, when tₛₜₐᵣₜ^{traj,j}≤tₐᵣᵣᵢᵥₑ^{traj,j}, and i={1, 2, . . . , n−1}, j={i+1, i+2, . . . , n}, the two navigation trajectories may be formed into one pair of navigation trajectories, and this pair of navigation trajectories may be stored in the matrix C, where C={c₁, c₂, . . . , cₖ, . . . , cₘ}, and cₖ={trajᵢ, trajⱼ}. That is, the matrix stores all pairs of navigation trajectories within the specified water area during a period of time.

At step 302, for each pair of navigation trajectories within the designated water area, perform interpolation processing on the two navigation trajectories of the pair of navigation trajectories respectively to acquire two interpolated navigation trajectories.

In an embodiment of the present application, considering that each navigation trajectory usually adopts a time format “year-month-day-hour-minute-second”, for the convenience of calculation, the time may be converted into seconds first. Due to the sparseness of the data transmitted by the AIS, in order to analyze the change law of the near-miss collisions in depth, a cubic spline interpolation method is used to interpolate each navigation trajectory of each pair of navigation trajectories in this embodiment of the present application. Specifically, the navigation trajectory may be directly acquired by interpolating the positions of the ship (that is, the latitude and longitude of the ship). Considering that the collision risk between ships is also related to the navigation speed and navigation direction of the ship, the navigation speed and navigation direction of the ship will also be interpolated here. That is, the navigation trajectory is interpolated based on the three dimensions of the position, navigation speed and navigation direction.

It should be noted that when interpolating the navigation direction, the particularity of the navigation direction needs to be considered. For example, if the navigation direction is from 030 to 060, the cubic spline interpolation method may be used directly; but when the navigation direction of the ship changes from 350 to 010, the traditional interpolation method will consider that the change of the navigation direction of the ship is to be 350-345- . . . -015-010, however, the actual change of the navigation direction of the ship is 350-355- . . . -010. Based on this, when interpolating the navigation direction, the following processing must be done first:

the navigation direction is θᵢ at time tᵢ (i=1, 2, . . . , n), and θᵢ₊₁ at time tᵢ₊₁, then the calculation method for interpolating the navigation direction is:

|θᵢ₊₁−θᵢ|≥180,min(θᵢ,θᵢ₊₁)=min(θᵢ,θᵢ₊₁)+360,max(θᵢ,θᵢ₊₁)=max(θᵢ,θᵢ₊₁)

|θᵢ₊₁−θᵢ|<180,(θᵢ=θᵢ,θᵢ₊₁=θᵢ₊₁);

next interpolation processing is performed according to the cubic spline interpolation method, and a calculated result needs to be converted as follows:

$$\{ \begin{matrix}0 < \frac{{θ}_{j}}{360} \leq 1 , & {θ}_{j} = {θ}_{j} \\ \frac{{θ}_{j}}{360} > 1 , & {θ}_{j} = {θ}_{j} - 360.\end{matrix}$$

At step 303, detect whether the minimum relative distance of the two interpolated navigation trajectories is smaller than the preset threshold.

In an embodiment of the present application, after acquiring two interpolated navigation trajectories, the relative distances of two trajectory points at the same time in the two navigation trajectories may be calculated to acquire the minimum relative distance of the two navigation trajectories. Subsequently, the minimum relative distance is compared with the preset threshold to determine whether the minimum relative distance is less than the preset threshold.

At step 304, if the minimum relative distance of the two interpolated navigation trajectories is less than the preset threshold, store the pair of the navigation trajectories composed of the two interpolated navigation trajectories in the near-miss collision database.

In an embodiment of the present application, when the minimum relative distance of the two interpolated navigation trajectories is less than the preset threshold, the two navigation trajectories are considered to be a situation of near-miss collision. That is, although two ships corresponding to the two navigation trajectories were relatively close for a time during the voyage, and there was high possibility to cause a collision, but the collision accident did not happen in reality due to the good ship handling techniques by deck officer. Based on this, such two interpolated navigation trajectories may be stored as one pair of navigation trajectories in the near-miss collision database, so as to provide a data basis for the subsequent construction of the adaptive collision risk assessment model.

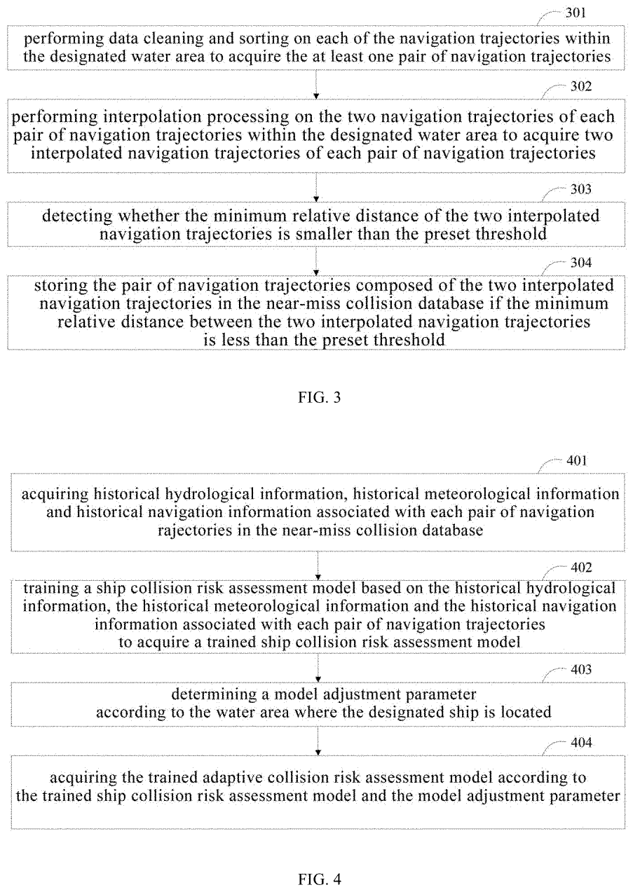

In order to better understand the embodiments of the present application, the adaptive collision risk assessment model is explained and described here. Please refer to FIG. 4. FIG. 4 shows the construction process of the adaptive collision risk assessment model, which includes the following.

At step 401, acquire historical hydrological information, historical meteorological information, and historical navigation information associated with each pair of navigation trajectories in the near-miss collision database.

In an embodiment of the present application, it can be known from the step 301 that the navigation trajectories of each pair of navigation trajectories in the near-miss collision database are determined by the position of the ship, and the navigation speed and navigation direction of the ship at each trajectory point of the navigation trajectory are acquired through interpolation processing, and at the same time the hydrological information and meteorological information associated with each navigation trajectory are also acquired. Based on this, for each pair of navigation trajectories, the relative distance, relative navigation speed and relative navigation direction at every same moment may be acquired. In addition, as for the hydrological information and meteorological information, it is generally believed that the hydrology and meteorology will not change significantly within a certain water area, and the minimum relative distance of each pair of navigation trajectories in the near-miss collision database is less than the preset threshold, therefore the hydrological information and meteorological information of the trajectory points at the same moment in each pair of navigation trajectories may be considered the same in order to facilitate calculation. Based on this, the historical hydrological information, historical meteorological information, and historical navigation information associated with each pair of navigation trajectories in the near-miss collision database may be acquired. That is, within the overlapping time of each pair of navigation trajectories, the historical hydrological information and historical meteorological information at every moment are acquired, and the historical navigation information of two trajectory points at the same moment are calculated at the same time, so as to acquire the historical relative distance, historical relative navigation speed and historical relative navigation direction at every same moment.

At step 402, train a ship collision risk assessment model based on the historical hydrological information, historical meteorological information and historical navigation information associated with each pair of navigation trajectories to acquire a trained ship collision risk assessment model.

In an embodiment of the present application, there are a plurality of influencing factors that affect the ship collision risk, including but not limited to the relative distance, relative navigation speed and relative navigation direction between the ships, as well as wind speed, visibility, flow rate, and wave height, etc. Due to space limitations, several representative influencing factors (the relative distance, the relative navigation speed, the relative navigation direction, the wind speed, and the visibility) are introduced herein.

As for the relative distance, it is generally believed that the ship collision risk decreases as the relative distance between ships increases. Specifically, taking a first ship 1 and a second ship 2 as an example, their relative distance may be calculated through the following formula:

$$x = 2 arcsin \sqrt{{sin}^{2} \frac{a}{2} + cos ( lat 1 ) \times cos ( lat 2 ) \times {sin}^{2} \frac{b}{2}} \times R ,$$

where R is the radius of the earth which is generally 6371 km, lat1 is the latitude of the first ship 1, lat2 is the latitude of the second ship 2, lon1 is the longitude of first ship 1, lon2 is the longitude of the second ship 2, and the units of lat1, lat2, lon1 and lon2 are in radians, and a=lat2−lat1, b=lon2−lon1.

As for the relative navigation speed, it refers to a change rate of the distance between two ships, which may be calculated from the navigation direction and navigation speed of the two ships. It is generally believed that the higher the relative navigation speed between the ships, the less processing time reserved for the deck officer. Therefore, it is believed that the ship collision risk is inversely proportional to the relative navigation speed. Specifically, the relative navigation speed between the ships may be calculated by the law of cosines:

c=\sqrt{a²+b²−2ab cos C},

where a and b represent the navigation speeds of the two ships respectively, c is the relative navigation speed, and C represents an angle between the navigation directions of the two ships which may be acquired by the following formula:

$$C = \{ \begin{matrix}\vert {C}_{1} - {C}_{2} \vert , & \vert {C}_{1} - {C}_{2} \vert \leq 180 \\ 360 - \vert {C}_{1} - {C}_{2} \vert , & \vert {C}_{1} - {C}_{2} \vert > 180.\end{matrix}$$

As for the relative navigation direction, it describes the relative position between two ships, which determines the magnitude of the change of the navigation direction during a collision avoidance operation for the ship. The positive or negative of the relative navigation direction represents whether the ship is at risk, the positive value indicates that two ships are approaching to each other and there is a collision risk, while the negative value indicates that there is no risk.

Regarding the visibility, although the current high-precision radar can accurately identify targets nearby, but the radar is susceptible to external environmental conditions, and the deck officers still need to maintain a proper lookout to identify the risk during the voyage. Therefore, good visibility is still very important for ship collision avoidance, and the deck officer needs to maintain a reasonable lookout.

Regarding the wind speed, considering that the wind will cause the ship to deviate from its scheduled route, it is necessary to consider the impact of the wind speed in the collision avoidance operation.

Based on the historical hydrological information, historical meteorological information and historical navigation information associated with each pair of navigation trajectories, the relationship between each of the influencing factors and the ship collision risk is studied, and the relational expression between each of the influencing factors and the ship conflict is acquired. It should be noted that in general, under ideal conditions, the relative distance, relative navigation speed, and relative navigation direction are considered to have a linear relationship with the ship collision risk, while the visibility and wind speed have a non-linear relationship with the ship collision risk. Just taking as an example, the relational expression between each of the influencing factors and the ship collision risk is as follows: Riskᵢ□f(d⁻¹), f(v), f(h) . . . .

Since only the relative distance, relative navigation speed and relative navigation direction have a linear relationship with the ship collision risk, the above formula only expresses three influencing factors, i.e., the relative distance, relative navigation speed and relative navigation direction. Among them, Riskᵢ represents the conflict risk between the i-th pair of navigation trajectories, where i=1, 2, . . . , L, f(d⁻¹), f(v) and f(h) represent linear expressions about the relative distance, relative navigation speed, and relative navigation direction respectively. Specifically, the relative distance is negatively correlated to the collision risk, and both the relative navigation speed and the relative navigation direction are positively correlated to the collision risk. That is, the above relational expression is the ship collision risk assessment model.

For example, at the moment T1, the relative navigation speed of the ship A and the ship B is V1, the relative distance between the ship A and the ship B is D1, the relative navigation direction of the ship A and the ship B is H1, the visibility is Vi1, and the wind speed is WS1, then a research staff can subjectively set the collision risk of the ship A and the ship B at the moment T1 as R1; the relative navigation speed, relative distance, relative navigation direction, visibility and wind speed of the ship A and the ship B at the moment T2 as V2, D2, H2, Vi2, and WS2 respectively, and the research staff can subjectively set the collision risk of the ship A and the ship B at the moment T2 as R2; and the rest can be done in the same manner. The data of multiple sets of influencing factors and the collision risk corresponding to each set of influencing factors are acquired, and the relationship between the influencing factors and the ship collision risk is studied based on this, and the parameters in the above relational expression are adjusted and the parameters are fitted by using methods such as the least square method to acquire the trained ship collision risk assessment model.

It should be noted that the embodiments of the present application do not list all influencing factors. For example, the type of the ship also has an impact on the collision risk. Because some special ships such as a chemical tanker loaded with hazardous chemical substance, despite other conditions being the same, are under higher risk, the corresponding collision risk will also increase. For example again, the higher the flow rate of the water area, the more difficult it is to effectively control the ship, which will thereby increase the corresponding collision risk. For example again, the fatigue level of the deck officer, the maneuverability of the ship and the management measures in specific water areas etc. also affect the collision avoidance, which will not be repeated herein again.

At step 403, determine a model adjustment parameter according to the water area where the designated ship is located.

In an embodiment of the present application, the acquired trained ship collision risk assessment model is a universal model. In some special water areas, for example, when the ship navigates within a water area with a traffic separation scheme, the value of the collision risk output by the above-trained ship collision risk assessment model is often correspondingly high, but in fact there is no potential collision risk between ships. Therefore, in some special water areas, a model adjustment parameter is needed to adjust the above-mentioned universal model.

At step 404, acquire the trained adaptive collision risk assessment model according to the trained ship collision risk assessment model and the model adjustment parameter.

For example, the trained ship collision risk assessment model is: Riskᵢ□f(d⁻¹), f(v), f(h) . . . , then based on the above trained ship collision risk assessment model and the above model adjustment parameter k, the acquired trained adaptive collision risk assessment model is: Riskᵢ=k·f(d⁻¹)·f(v)·f(h) . . . . For different water areas, the aforementioned model adjustment parameter k will also be changed accordingly, thus the output collision risk may be adjusted through the model adjustment parameter k, so that the acquired collision risk conforms to the actual situation of the water area.

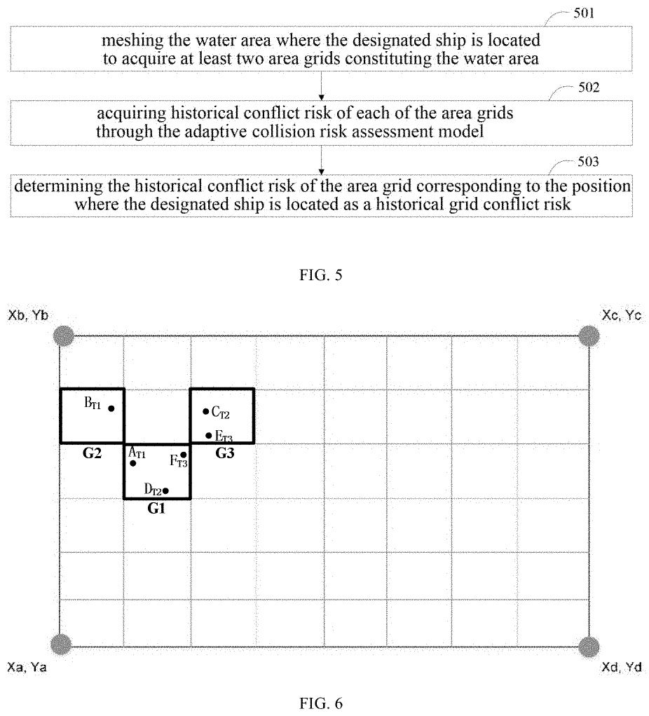

In some embodiments, in addition to the real-time collision risk, the grid historical collision risk may also be calculated through the adaptive collision risk assessment model. Please refer to FIG. 5. FIG. 5 shows the implementation process of acquiring the historical grid conflict risk, which is detailed as follows.

At step 501, mesh the water area where the designated ship is located to acquire at least two area grids constituting the water area.

In an embodiment of the present application, the water area where the designated ship is located may be meshed, that is, the water area where the designated ship is located is divided into at least two area grids. Generally speaking, the sizes of these area grids are the same, and the size of grid in different water areas is depend on relevant resolution requirement and other maritime regulations.

At step 502, acquire historical conflict risk of each of the area grids through the adaptive collision risk assessment model.

In an embodiment of the present application, the historical conflict risk of each of the area grids may be calculated through the adaptive collision risk assessment model as mentioned above. The specific process is as follows: the largest collision risk value of each pair of navigation trajectories within the water area where the designated ship is located is acquired through the above adaptive collision risk assessment model, and then two target trajectory points in each pair of navigation trajectories are determined, where the above two target trajectory points are two trajectory points corresponding to the largest collision risk value of this pair of navigation trajectories, and next the largest collision risk values corresponding to the target trajectory points within the water area are accumulated for each area grid to acquire the historical collision risk of the area grid.

That is, during a period of time (for example, one month), the ships navigation in this water area are monitored to acquire a plurality of navigation trajectories, and at least two pairs of navigation trajectories are acquired through operations such as data cleaning, sorting, and interpolation processing. The specific process is similar to the step 301 and the step 302, and will not be repeated herein. After acquiring at least two pairs of navigation trajectories in this water area, the collision risk corresponding to two trajectory points at each moment is calculated through the adaptive collision risk assessment model for each pair of navigation trajectories, and the largest collision risk value of this pair of navigation trajectories is acquired through comparison. Obviously, the largest collision risk value must correspond to two trajectory points, where one trajectory point is located in one navigation trajectory of this pair of navigation trajectories, and another trajectory point is located in another navigation trajectory of this pair of navigation trajectories, and these two trajectory points are recorded as the target trajectory points of this pair of navigation trajectories. Assuming that there are N pairs of navigation trajectories in this water area, and there are corresponding two target trajectory points for each pair of navigation trajectories, then there are 2N target trajectory points in total. Based on these 2N target trajectory points, the historical conflict risks of the area grids may be determined.

For example, please refer to FIG. 6. Assuming that the water area where the designated ship is located is divided into area grids as shown in FIG. 6. It is also assumed that the ships navigating in this water area are monitored during a period of time, and three pairs of navigation trajectories are acquired. The navigation trajectories of the ship A and the ship B constitute a first pair of navigation trajectories, the navigation trajectories of the ship C and the ship D constitute a second pair of navigation trajectories, and the navigation trajectories of the ship E and the ship F constitute a third pair of navigation trajectories.

Assuming, based on calculating the first pair of navigation trajectories through the adaptive collision risk assessment model, that the highest collision risk R1 of the ship A and the ship B is at time T1, then the trajectory point A_{T1} at the time T1 of the navigation trajectory of the ship A and the trajectory point B_{T1} at the time T1 of the navigation trajectory of the ship B may be acquired.

Assuming, based on calculating the second pair of navigation trajectories through the adaptive collision risk assessment model, that the highest collision risk R2 of the ship C and the ship D is at time T2, then the trajectory point C_{T2} at the time T2 of the navigation trajectory of the ship C and the trajectory point D_{T2} at the time T2 of the navigation trajectory of the ship D may be acquired.

Assuming, based on calculating the third pair of navigation trajectories through the adaptive collision risk assessment model, that the highest collision risk R3 of the ship E and the ship F is at time T3, then the trajectory point E_{T3} at the time T3 of the navigation trajectory of the ship E and the trajectory point F_{T3} at the time T3 of the navigation trajectory of the ship F may be acquired.

The area grids into which the above-mentioned A_{T1}, B_{T1}, C_{T2}, D_{T2}, E_{T3}, and F_{T3} fall are shown in FIG. 6. Among them, A_{T1}, D_{T2}, and F_{T3} all fall into the area grid G1, R_{T1} falls into the area grid G2, and C_{T2} and E_{T3} fall into the area grid G3. Then, the collision risk of the area grid G1 is equal to R1+R2+R3, the collision risk of the area grid G2 is equal to R1; the collision risk of the area grid G3 is equal to R2+R3.

At step 503: determine the historical conflict risk of the area grid corresponding to the location of the designated ship as the historical grid conflict risk.

In an embodiment of the present application, when the designated ship navigates into a certain area grid, the historical conflict risk of this area grid may be determined as the historical grid conflict risk, and the historical grid conflict risk is specifically used to indicate risk profile of the location where the designated ship is currently located. Correspondingly, after the historical grid conflict risk is acquired, the step 103 may specifically refer to determining the risk level of the designated ship based on the real-time collision risk and the historical grid conflict risk. That is, the historical grid conflict risk (the historical conflict risk of the area grid where the designated ship is located) will also affect the risk level of the designated ship. It can be considered that, like the collision risk, the risk levels are also divided into two types: one is a real-time risk level associated with the real-time collision risk, which is usually acquired based on real-time data (such as real-time meteorological information, real-time hydrological information, and real-time navigation information); another is an area risk level associated with the historical grid conflict risk (that is, the historical conflict risk of the area grid), which is usually acquired based on historical data (such as historical meteorological information, historical hydrological information, and historical navigation information).

In some embodiments, the step 104 may refer to outputting the early warning message associated with the real-time risk level to the designated ship when the real-time risk level is higher than the preset real-time risk level threshold, or outputting the early warning message associated with the historical grid conflict risk level to the designated ship when the historical grid conflict risk level is medium or high. It can be seen that the designated ship will not receive the early warning message only when both the real-time collision risk and historical grid conflict risk of the designated ship are low.

In some embodiments, the historical grid conflict risk (that is, the historical conflict risk of the area grid where the specified ship is located) may also be adjusted based on the probability of historical ship collision accidents. Exemplarily, the probability of the historical ship collision accidents in the area grid corresponding to the location of the designated ship may firstly acquired, and then the historical grid conflict risk (that is, the historical conflict risk of the area grid) is adjusted according to the probability. Just as an example, the probability may be calculated through: counting the number of ships that have navigated into the area grid within a period of time, and counting the number of times of ship collisions during the period of time at the same time, and taking the ratio of the number to the number of times as the probability of ship collision accidents. Of course, the probability may also be calculated in other ways, which is not limited herein.

In some embodiments, a plurality of non-overlapping small probability intervals may be pre-divided, and each of the small probability intervals corresponds to one collision risk adjustment value. For example, there may be three divided small probability intervals, i.e., [0,0.02), [0.02,0.1), and [0.1,0.25], where the collision risk adjustment value corresponding to [0,0.02) is 0, the collision risk adjustment value corresponding to [0.02,0.1) is Y1, the collision risk adjustment value corresponding to [0.02,0.1) is Y2, and Y1 is less than Y2. Assuming that the probability of ship collision accidents in the area grid where the specified ship is currently located is 0.03, which falls into the small probability interval [0.02, 0.1), then the historical grid conflict risk (that is, the historical conflict risk of this area grid) plus the collision risk adjustment value Y2 corresponding to this small probability interval to acquire the adjusted historical grid conflict risk. Subsequently, the risk level (or historical risk level) of the designated ship may be determined based on the adjusted historical grid conflict risk.

In some embodiments, the historical grid conflict risk may also be adjusted according to the location and the number of ship collision accidents. Exemplarily, the number of ship collision accidents within the water area corresponding to the location of the designated ship may first acquired, and then the historical grid conflict risk (that is, the historical conflict risk of this area grid) may be adjusted according to the aforementioned number of times. The historical grid conflict risk may be adjusted upward by one level when every N (N is a preset positive integer) times of collision accidents occurred, until the historical grid conflict risk reaches its highest level.

That is, in this embodiment of the present application, whether a ship collision accident occurs may be used as a reference for evaluating the area grid.

In some embodiments, the ship-borne device mounted on the designated ship has a display screen, which may be used to display a user interface. For convenience of deck officer's inspection, the designated ship avoids dangerous areas as much as possible during the voyage, and may also mark a virtual sea chart of the water area where the designated ship is located based on the historical conflict risk of the area grids in the water area where the designated ship is located, and output the marked virtual sea chart to the ship-borne device of the designated ship, so that the display screen of the ship-borne device displays the marked virtual sea chart. The mark may be a highlighted mark, or other methods may also be used for marking, which is not limited herein. In addition, the ship-borne device may also display real-time ship positions of this ship and other ships and water traffic accident data and the like, which is not limited herein.

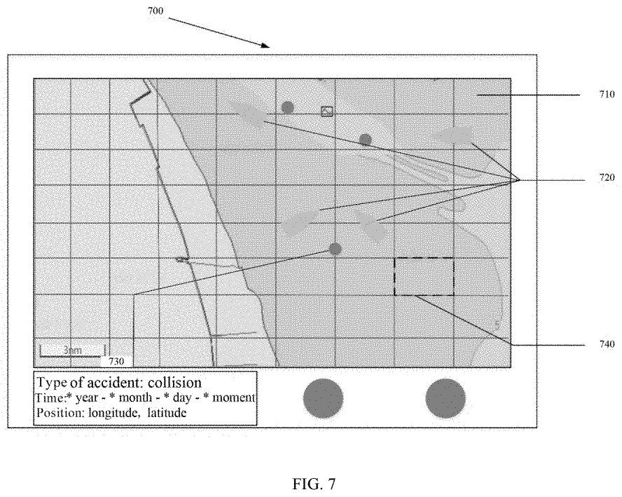

Please refer to FIG. 7. FIG. 7 shows a schematic diagram of the user interface displayed on the display screen of the ship-borne device. The user interface 700 includes: a virtual sea chart 710, real-time positions 720 of the designated ship and nearby ships represented by graphics, locations 730 of historical water traffic accidents represented by dots, and the risk level 740 of the water grid. The user interface supports human-computer interactive operations. For example, when the user clicks on a location of an accident or a real-time ship position on the user interface, relevant navigation information will be displayed on the user interface. In addition, the real-time position data of the ship will change in real time on the user interface as the ship moves. Further, data visualization technology may also be applied to the user interface, and different color saturations may be used to indicate the historical conflict risks of the area grids. Specifically, the higher the color saturation, the greater the historical conflict risk of the area grid.

In an application scenario, the execution subject of each step proposed in the embodiments of the present application may be the same electronic device. For example, it may be a server, or a ship-borne device of the designated ship.

In another application scenario, the execution subjects of the steps proposed in the embodiments of the present application may be different electronic devices. Please refer to FIG. 8. FIG. 8 shows a schematic diagram of a scene when the execution subjects are different electronic devices. The ship can exchange navigation-related information 803 with other ships through AIS or other transmission methods for collision avoidance actions (as shown by 802A and 802B). The transmission cycle for the AIS data depends on the navigation speed of this ship, which is generally 2-10 seconds. When the ship is at an anchoring state, the transmission cycle is 3 minutes. Of course, other data transmission methods may also be used, which is not limited herein. The ship may acquire its own position information through a positioning device such as a GPS. Other navigation information, such as the navigation speed and navigation direction, may be acquired through a sensor on the ship. The hydrological information and meteorological information may be acquired by a sensor mounted on a top deck of the ship, or by receiving information issued by an official department.

It should be understood that in the calculation process of the historical conflict risks of the area grids, the information (the hydrological information, the meteorological information and the navigation information) acquired by each ship may be transmitted by a transmission line 804A from the ship to the satellite, a transmission line 805A from the satellite to the satellite, a transmission line 805B from the satellite to the shore-based base station (open water area), a transmission line 804B from the ship to the water-base station, a transmission line 806 from the overwater station to the shore-based base station (inshore water area), and other transmission methods not mentioned in the embodiments of this application to transmit to the shore-based base station. The shore-based base station can acquire the historical hydrological information, historical meteorological information, and historical navigation information for a period of time based on this, and acquire the historical conflict risk of each of the area grids through calculation, thereby laying a foundation for subsequently providing the historical conflict risk of the area grid (that is, the historical grid conflict risk) where the designated ship is located.

During the process of calculating the real-time ship collision risk, the ship-borne device of the ship may directly acquire the real-time hydrological information, meteorological information and navigation information, and calculate the real-time ship collision risk by using a high-performance computation method such as parallel computation and the like.

For example, when the ship in a certain water area just starts to apply method for assessing ship collision risk assessment and early warning proposed in the embodiments of the present application, the shore-based base station has not yet been able to calculate the historical conflict risk of each of the area grids since historical data may be not previously stored in the shore-based base station. When the ship is navigation in this water area, it calculates the real-time collision risk through its own ship-borne device, meanwhile sends the acquired hydrological information, meteorological information and navigation information to the shore-based base station for storage as a calculation basis of the historical conflict risk of each of the area grids. After a period of time, the shore-based base station has collected the hydrological information, meteorological information and navigation information of each ship within this water area during this period of time, thus the shore-based base station may calculate the historical conflict risk of each of the area grids. At the same time, when each ship navigates within this water area, it still calculates the real-time collision risk through its own ship-borne device while sending the acquired hydrological information, meteorological information and navigation information to the shore-based base station for storage, so that the historical data collected by the shore-based base station may be continuously updated, and the historical conflict risk of each area grid may be continuously updated accordingly.

It can be seen from the above that, when constructing the adaptive collision risk assessment model in an embodiment of the present application, on the one hand not only the navigation information among ships is taken into consideration but also the hydrological information and meteorological information of the ship during voyage, on the other hand different model adjustment parameters are set according to different water areas. Based on the above two measures, the collision risk output by the adaptive collision risk assessment model is more accurate. Through this adaptive collision risk assessment model, the ship collision risk may be assessed by combining the past information and the information during the current voyage when the ship is navigating, which can improve the assessment accuracy of the ship collision risk and the timeliness of early warning.

It should be understood that, the sequence number of each step in the foregoing embodiments does not mean the order of execution, and the execution sequence of each step should be determined by its function and internal logic and should not constitute any limitation to the implementation process of the embodiments of the present application.

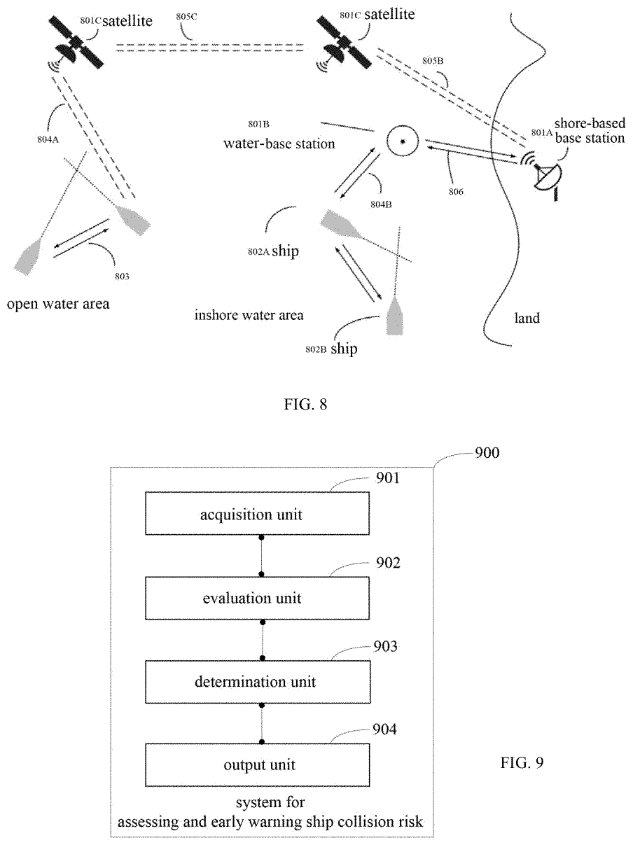

Corresponding to the method for assessing and early warning ship collision risk provided above, an embodiment of the present application further provides a system for assessing and early warning ship collision risk. Referring to FIG. 9, the system 900 for assessing and early warning ship collision risk in this embodiment of the present application includes:

an acquisition unit 901, configured to acquire hydrological information and meteorological information of a position where a designated ship is located, and acquire navigation information of the designated ship and other ships, here the navigation information includes navigation speeds, navigation directions, and positions;

an evaluation unit 902, configured to acquire real-time collision risk of the designated ship through evaluation of a trained adaptive collision risk assessment model based on the hydrological information, the meteorological information and the navigation information, here the adaptive collision risk assessment model is constructed according to a preset near-miss collision database and a water area where the designated ship is located, and the near-miss collision database includes at least one pair of navigation trajectories, and the minimum relative distance of two navigation trajectories in each pair of navigation trajectories is less than a preset threshold;

a determination unit 903, configured to determine a risk level of the designated ship according to the real-time collision risk;

an output unit 904, configured to output an early warning message associated with the risk level to the designated ship.

Optionally, the system 900 for assessing and early warning ship collision risk further includes:

a preprocessing unit, configured to perform data cleaning and sorting on each of the navigation trajectories within the designated water area to acquire at least one pair of navigation trajectories;

an interpolation processing unit, configured to perform interpolation processing on the two navigation trajectories of each pair of navigation trajectories within the designated water area to acquire two interpolated navigation trajectories of each pair of navigation trajectories;

a distance detection unit, configured to detect whether the minimum relative distance of the two interpolated navigation trajectories is smaller than the preset threshold;

a data storage unit, configured to store the pair of navigation trajectories composed of the two interpolated navigation trajectories in the near-miss collision database if the minimum relative distance between the two interpolated navigation trajectories is less than the preset threshold.

Optionally, the system 900 for assessing and early warning ship collision risk further includes:

a historical data acquisition unit, configured to acquire historical hydrological information, historical meteorological information and historical navigation information associated with each pair of navigation trajectories in the near-miss collision database;

a model training unit, configured to train the ship collision risk assessment model to be trained based on the historical hydrological information, historical meteorological information and historical navigation information associated with each pair of navigation trajectories to acquire the trained ship collision risk assessment model;

a parameter determination unit, configured to determine a model adjustment parameter according to the water area where the designated ship is located;

a model acquisition unit, configured to acquire a trained adaptive collision risk assessment model according to the trained ship collision risk assessment model and the model adjustment parameter.

Optionally, the system 900 for assessing and early warning ship collision risk further includes:

an area meshing unit, configured to mesh the water area where the designated ship is located to acquire at least two area grids constituting the water area;

an area risk calculation unit, configured to acquire historical conflict risk of each of the area grids through the adaptive collision risk assessment model;

a historical grid conflict risk determination unit, configured to determine the historical conflict risk of the area grid corresponding to the position where the designated ship is located as the historical grid conflict risk;

correspondingly, the determination unit 903 is specifically configured to determine the risk level of the designated ship according to the real-time collision risk and the historical grid conflict risk.

Optionally, the system 900 for assessing and early warning ship collision risk further includes:

an accident probability acquisition unit, configured to acquire probability of a ship collision accident in the area grid corresponding to the position where the designated ship is located;

a historical grid conflict risk adjustment unit, configured to adjust the historical grid conflict risk according to the probability;

correspondingly, the determination unit 903 is specifically configured to determine the risk level of the designated ship according to the real-time collision risk and the adjusted historical grid conflict risk.

Optionally, the area risk calculation unit includes:

a first calculation subunit, configured to calculate the largest collision risk value of each pair of navigation trajectories within the water area where the designated ship is located through the adaptive collision risk assessment model;

a trajectory point determination subunit, configured to determine two target trajectory points in each pair of navigation trajectories, where the two target trajectory points are two trajectory points corresponding to the largest collision risk value of one pair of navigation trajectories;

a second calculation subunit, configured to accumulate the largest collision risk values corresponding to the target trajectory points within the area grid for each of the area grids to acquire the historical collision risk of the area grid.

Optionally, the system 900 for assessing and early warning ship collision risk further includes:

a virtual sea chart marking unit, configured to mark a virtual sea chart of the water area according to the historical conflict risk of each of the area grids;

a virtual sea chart output unit, configured to output the marked virtual sea chart to the designated ship.

It can be seen from the above that, when constructing the adaptive collision risk assessment model in the embodiment of the present application, on the one hand not only the navigation information between ships is taken into consideration but also the hydrological information and meteorological information during voyage of the ship, on the other hand different model adjustment parameters are set for different water areas such that the collision risk output by the adaptive collision risk assessment model is more accurate based on the above two measures. Through this adaptive collision risk assessment model, the ship collision risk may be assessed by combining the historical information and the information during the current voyage when the ship is navigating, which can improve the assessment accuracy of the collision risk and the timeliness of early warning.

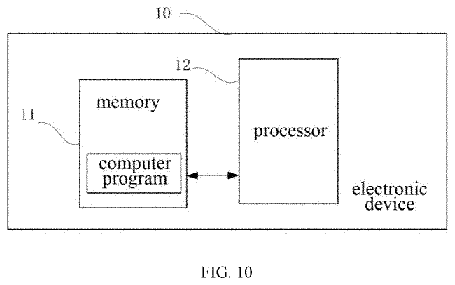

Corresponding to the method for assessing and early warning ship collision risk provided above, an embodiment of the present application further provides an electronic device. Referring to FIG. 10, the electronic device 10 in this embodiment of the present application includes: a memory 11, one or more processors 12 (only one is shown in FIG. 9) and a computer program stored on the memory 11 and capable of being executed on the processor, such as the program including the method for assessing and early warning ship collision risk. When executing the computer program, the processor 12 implements the steps in each embodiment of the method for assessing and early warning ship collision risk, such as steps from 101 to 104 as shown in FIG. 1. Alternatively, when executing the computer program, the processor 12 implements the functions of the units in the embodiment corresponding to FIG. 9, for example, the functions of the units from 901 to 904 as shown in FIG. 9. For details, please refer to related description in the embodiment corresponding to FIG. 9, which is not repeated herein.

Exemplarily, the above computer program may be divided into one or more units, and the one or more units are stored in the memory 11 and executed by the processor 12 to complete the present application. The one or more units may be a series of computer program instruction segments capable of completing specific functions, and the instruction segments are used to describe the execution process of the computer program in the electronic device 10. For example, the computer program may be divided into an acquisition unit, an evaluation unit, a determination unit, and an output unit, and the specific functions of the units are described as above.

The above-mentioned electronic device may include, but is not limited to, the processor 12 and the memory 11. Those skilled in the art can understand that FIG. 10 is only an example of the electronic device 10, and does not constitute a limitation on the electronic device 10, which may include more or less components than that in the figure, or a combination of certain components, or different components. For example, the above-mentioned electronic device may further include an input and output device, a network access device, a bus, and so on.

The processor 12 may be a CPU (Central Processing Unit), or may be other general-purpose processor, DSP (Digital Signal Processor), ASIC (Application Specific Integrated Circuit), FPGA (Field-Programmable Gate Array,) or other programmable logic device, discrete gate or transistor logic device, discrete hardware component, etc. The general-purpose processor may be a microprocessor or the processor may also be any conventional processor or the like.

The memory 11 may be an internal storage unit of the electronic device 10, such as a hard disk or a storage of the electronic device 10. The memory 11 may also be an external storage device of the electronic device 10, such as a plug-in hard disk, a SMC (Smart Media Card), a SD (Secure Digital) card, and a flash card etc. equipped on the electronic device 10. Further, the memory 11 may also include both an internal storage unit and an external storage device of the electronic device 10. The memory 11 is used to store the computer program and other programs and data required by the electronic device. The memory 11 can also be used to temporarily store data that has been output or will be output.

It should be understood that, in the embodiments of the present application, the processor 12 may be a CPU (Central Processing Unit), or may be other general-purpose processor, DSP (Digital Signal Processor), ASIC (Application Specific Integrated Circuit), FPGA (Field-Programmable Gate Array,) or other programmable logic device, discrete gate or transistor logic device, discrete hardware component, etc. The general-purpose processor may be a microprocessor or the processor may also be any conventional processor or the like.

The memory 11 may include a read-only memory and a random access memory, and provide an instruction and data to the processor 12. A part or all of the memory 11 may also include a non-volatile random access memory. For example, the memory 11 may also store information about the type of the device.

It can be seen from the above that, when constructing the adaptive collision risk assessment model in the embodiment of the present application, on the one hand not only the navigation information between ships is taken into consideration but also the hydrological information and meteorological information during voyage, on the other hand different model adjustment parameters are set for different water area such that the collision risk output by the adaptive collision risk assessment model is more accurate based on the above two measures. Through this adaptive collision risk assessment model, the ship collision risk may be assessed by combining the historical information and the information during the current voyage when the ship is navigating, which can improve the assessment accuracy of the collision risk and the timeliness of early warning.

It will be clearly understood by those skilled in the art that, for convenience and brevity of description, the division of the various functional units or modules described above is only exemplified. In practical applications, the above functions may be completed through assigning it to different functional units or modules according to needs. That is, the internal structure of the system is divided into different functional units or modules to perform all or part of the functions described above. The various functional units or modules in the embodiments may be integrated into one processing unit, or each of the units may exist physically separately, or two or more units may be integrated into one unit. The above integrated unit may be implemented in a form of hardware, or may be implemented in a form of software functional unit. In addition, the specific names of the respective functional units or modules are only for the purpose of facilitating mutual differentiation, and are not intended to limit the protection scope of the present application. In the specific working process of the units or the modules in the foregoing system, reference may be made to the corresponding process in the foregoing method embodiments, and details of which will be not described herein again.

In the above embodiments, each of the embodiments is described with particular emphasis, and parts that are not detailed or described in a certain embodiment may refer to related description of other embodiments.

Those of ordinary skill in the art will appreciate that, the exemplary units and algorithm steps described in combination with the embodiments disclosed herein may be implemented by electronic hardware, or a combination of software of an external device and electronic hardware. Whether these functions are performed in hardware or software depends on a specific application and a design constraint of the technical solution. A person skilled in the art may use different methods to implement the described functions for each particular application, and such implementation should not be considered to be beyond the scope of the present application.

In the embodiments provided by the present application, it should be understood that the disclosed system and method may be implemented in other manners. For example, the system embodiments described above are merely illustrative. For example, the division of the modules or units is only a division for logical functions, and there may be other division manners in actual implementation, for example, a plurality of units or components may be combined or integrated into another system, or some features may be ignored or not executed. In addition, the mutual coupling or direct coupling or communication connection as shown or discussed may be indirect coupling or communication connection through some interfaces, systems or units, or may be electrical or mechanical, or may be in other forms.

The units described as separate components may or may not be physically separate. The components displayed as units may or may not be physical units, that is, may be located in one place, or may be distributed to a plurality of network units. Some or all of the units may be selected according to actual needs to achieve the purpose of the solutions of the embodiments.

The integrated unit, if implemented in the form of the software functional unit and sold or used as a stand-alone product, may be stored in a computer readable storage medium. Based on such understanding, the present application may implement all or part of the processes in the above embodiments through commanding related hardware by a computer program, and the computer program may be stored in the computer readable storage medium. The computer program, when executed by the processor, may implement the steps of the various method embodiments described above. Where, the computer program includes a computer program code, and the computer program code may be in a form of a source code, an object code, an executable file, or some intermediate forms. The computer readable medium may include: any entity or apparatus capable of carrying the computer program code, a recording medium, a USB flash disk, a removable hard disk, a magnetic disk, an optical disk, a computer-readable memory, a ROM (Read-Only Memory), a RAM (Random Access Memory), an electrical carrier signal, a telecommunication signal, or software distribution media or the like. It should be noted that, the content contained in the computer readable medium may be appropriately increased or decreased according to requirements of legislation and patent practice in a jurisdiction. For example, in some jurisdictions, according to the legislation and the patent practice, the computer readable medium does not include the electrical carrier signal and telecommunication signal.

The above embodiments are only used to illustrate the technical solutions of the present application, and are not intended to be limiting. Although the present application has been described in detail with reference to the foregoing embodiments, those of ordinary skill in the art should understand that the technical solutions disclosed in the above embodiments may be modified, or some of the technical features may be replaced by equivalents. These modifications or substitutions do not depart corresponding technical solutions from the spirit and scope of the technical solutions of the embodiments of the present application, and should be included in the protection scope of the present application.

What is claimed is:

1. A method for assessing and early warning ship collision risk, comprising:
acquiring hydrological information and meteorological information of a position where a designated ship is located, and acquiring navigation information of the designated ship and other ships, wherein the navigation information includes navigation speeds, navigation directions, and positions;
acquiring real-time collision risk of the designated ship through evaluation of a trained adaptive collision risk assessment model based on the hydrological information, the meteorological information and the navigation information, wherein the adaptive collision risk assessment model is constructed according to a preset near-miss collision database and a water area where the designated ship is located, the near-miss collision database comprises at least one pair of navigation trajectories, and the minimum relative distance of two navigation trajectories in each pair of navigation trajectories is less than a preset threshold;
determining a risk level of the designated ship according to the real-time collision risk;
outputting an early warning message associated with the risk level to the designated ship.

2. The method of claim 1, wherein the method further comprises:
performing data cleaning and sorting on each of the navigation trajectories within the designated water area to acquire the at least one pair of navigation trajectories;
performing interpolation processing on the two navigation trajectories of each pair of navigation trajectories within the designated water area to acquire two interpolated navigation trajectories of each pair of navigation trajectories;
detecting whether the minimum relative distance of the two interpolated navigation trajectories is smaller than the preset threshold;
storing the pair of navigation trajectories composed of the two interpolated navigation trajectories in the near-miss collision database if the minimum relative distance between the two interpolated navigation trajectories is less than the preset threshold.

3. The method of claim 1, wherein the method further comprises:
acquiring historical hydrological information, historical meteorological information and historical navigation information associated with each pair of navigation trajectories in the near-miss collision database;
training a ship collision risk assessment model based on the historical hydrological information, the historical meteorological information and the historical navigation information associated with each pair of navigation trajectories to acquire a trained ship collision risk assessment model;
determining a model adjustment parameter according to the water area where the designated ship is located;
acquiring the trained adaptive collision risk assessment model according to the trained ship collision risk assessment model and the model adjustment parameter.

4. The method of claim 1, wherein, before determining the risk level of the designated ship according to the real-time collision risk, the method further comprises:
meshing the water area where the designated ship is located to acquire at least two area grids constituting the water area;
acquiring historical conflict risk of each of the area grids through the adaptive collision risk assessment model;
determining the historical conflict risk of the area grid corresponding to the position where the designated ship is located as a historical grid conflict risk;
correspondingly, the step of determining the risk level of the designated ship according to the real-time collision risk comprises:
determining the risk level of the designated ship according to the real-time collision risk and the historical grid conflict risk.

5. The method of claim 4, wherein, after determining the historical conflict risk of the area grid corresponding to the position where the designated ship is located as a historical grid conflict risk, the method further comprises:
acquiring probability of a ship collision accident in the area grid corresponding to the position where the designated ship is located;
adjusting the historical grid conflict risk according to the probability;
correspondingly, the step of determining the risk level of the designated ship according to the real-time collision risk and the historical grid conflict risk comprises:
determining the risk level of the designated ship according to the real-time collision risk and the adjusted historical grid conflict risk.

6. The method of claim 4, wherein the step of acquiring the historical conflict risk of each of the area grids through the adaptive collision risk assessment model comprises:
calculating the largest collision risk value of each pair of navigation trajectories within the water area where the designated ship is located through the adaptive collision risk assessment model;
determining two target trajectory points in each pair of navigation trajectories, wherein the two target trajectory points are two trajectory points corresponding to the largest collision risk value of one pair of navigation trajectories;
accumulating the largest collision risk values corresponding to the target trajectory points within the area grid for each of the area grids to acquire the historical collision risk of each of the area grids.

7. The method of claim 4, wherein, after acquiring the historical conflict risk of each of the area grids through the adaptive collision risk assessment model, the method further comprises:
marking a virtual sea chart of the water area according to the historical conflict risk of each of the area grids;
outputting the marked virtual sea chart to the designated ship.

8. A system for assessing and early warning ship collision risk, comprising:
an acquisition unit, configured to acquire hydrological information and meteorological information of a position where a designated ship is located, and acquire navigation information of the designated ship and other ships, wherein the navigation information includes navigation speeds, navigation directions, and positions;
an evaluation unit, configured to acquire real-time collision risk of the designated ship through evaluation of a trained adaptive collision risk assessment model based on the hydrological information, the meteorological information and the navigation information, wherein the adaptive collision risk assessment model is constructed according to a preset near-miss collision database and a water area where the designated ship is located, the near-miss collision database comprises at least one pair of navigation trajectories, and the minimum relative distance of two navigation trajectories in each pair of navigation trajectories is less than a preset threshold;
a determination unit, configured to determine a risk level of the designated ship according to the real-time collision risk;
an output unit, configured to output an early warning message associated with the risk level to the designated ship.

9. The system of claim 8, wherein the system further comprises:
a preprocessing unit, configured to perform data cleaning and sorting on each of the navigation trajectories within the designated water area to acquire at least one pair of navigation trajectories;
an interpolation processing unit, configured to perform interpolation processing on the two navigation trajectories of each pair of navigation trajectories within the designated water area to acquire two interpolated navigation trajectories of each pair of navigation trajectories;
a distance detection unit, configured to detect whether the minimum relative distance of the two interpolated navigation trajectories is smaller than the preset threshold;
a data storage unit, configured to store the pair of navigation trajectories composed of the two interpolated navigation trajectories in the near-miss collision database if the minimum relative distance between the two interpolated navigation trajectories is less than the preset threshold.

10. The system of claim 8, wherein the system further comprises:
a historical data acquisition unit, configured to acquire historical hydrological information, historical meteorological information and historical navigation information associated with each pair of navigation trajectories in the near-miss collision database;
a model training unit, configured to train a ship collision risk assessment model to be trained based on the historical hydrological information, the historical meteorological information and the historical navigation information associated with each pair of navigation trajectories to acquire a trained ship collision risk assessment model;
a parameter determination unit, configured to determine a model adjustment parameter according to the water area where the designated ship is located;
a model acquisition unit, configured to acquire a trained adaptive collision risk assessment model according to the trained ship collision risk assessment model and the model adjustment parameter.

11. The system of claim 8, wherein the system further comprises:
an area meshing unit, configured to mesh the water area where the designated ship is located to acquire at least two area grids constituting the water area;
an area risk calculation unit, configured to acquire historical conflict risk of each of the area grids through the adaptive collision risk assessment model;
a historical grid conflict risk determination unit, configured to determine the historical conflict risk of the area grid corresponding to the position where the designated ship is located as a historical grid conflict risk;
correspondingly, the determination unit is specifically configured to determine the risk level of the designated ship according to the real-time collision risk and the historical grid conflict risk.

12. The system of claim 8, wherein the system further comprises:
an accident probability acquisition unit, configured to acquire probability of a ship collision accident in the area grid corresponding to the position where the designated ship is located;
a historical grid conflict risk adjustment unit, configured to adjust the historical grid conflict risk according to the probability;
correspondingly, the determination unit is specifically configured to determine the risk level of the designated ship according to the real-time collision risk and the adjusted historical grid conflict risk.

13. The system of claim 11, wherein the area risk calculation unit comprises:
a first calculation subunit, configured to calculate the largest collision risk value of each pair of navigation trajectories within the water area where the designated ship is located through the adaptive collision risk assessment model;
a trajectory point determination subunit, configured to determine two target trajectory points in each pair of navigation trajectories, where the two target trajectory points are two trajectory points corresponding to the largest collision risk value of one pair of navigation trajectories;
a second calculation subunit, configured to accumulate the largest collision risk values corresponding to the target trajectory points within the area grid for each of the area grids to acquire the historical collision risk of each of the area grids.

14. A computer-readable storage medium, in which a computer program is stored, wherein the computer program, when executed by a processor, implements the step of:
acquiring hydrological information and meteorological information of a position where a designated ship is located, and acquiring navigation information of the designated ship and other ships, wherein the navigation information includes navigation speeds, navigation directions, and positions;
acquiring real-time collision risk of the designated ship through evaluation of a trained adaptive collision risk assessment model based on the hydrological information, the meteorological information and the navigation information, wherein the adaptive collision risk assessment model is constructed according to a preset near-miss collision database and a water area where the designated ship is located, the near-miss collision database comprises at least one pair of navigation trajectories, and the minimum relative distance of two navigation trajectories in each pair of navigation trajectories is less than a preset threshold;
determining a risk level of the designated ship according to the real-time collision risk;
outputting an early warning message associated with the risk level to the designated ship.

15. The computer-readable storage medium of claim 14, wherein the computer program, when executed by a processor, further implements the steps of:
performing data cleaning and sorting on each of the navigation trajectories within the designated water area to acquire the at least one pair of navigation trajectories;
performing interpolation processing on the two navigation trajectories of each pair of navigation trajectories within the designated water area to acquire two interpolated navigation trajectories of each pair of navigation trajectories;
detecting whether the minimum relative distance of the two interpolated navigation trajectories is smaller than the preset threshold;
storing the pair of navigation trajectories composed of the two interpolated navigation trajectories in the near-miss collision database if the minimum relative distance between the two interpolated navigation trajectories is less than the preset threshold.

16. The computer-readable storage medium of claim 14, wherein the computer program, when executed by a processor, further implements the steps of:
acquiring historical hydrological information, historical meteorological information and historical navigation information associated with each pair of navigation trajectories in the near-miss collision database;
training a ship collision risk assessment model based on the historical hydrological information, the historical meteorological information and the historical navigation information associated with each pair of navigation trajectories to acquire a trained ship collision risk assessment model;
determining a model adjustment parameter according to the water area where the designated ship is located;
acquiring the trained adaptive collision risk assessment model according to the trained ship collision risk assessment model and the model adjustment parameter.

17. The computer-readable storage medium of claim 14, wherein the computer program, when executed by a processor, further implements, before determining the risk level of the designated ship according to the real-time collision risk, the steps of:
meshing the water area where the designated ship is located to acquire at least two area grids constituting the water area;
acquiring historical conflict risk of each of the area grids through the adaptive collision risk assessment model;
determining the historical conflict risk of the area grid corresponding to the position where the designated ship is located as a historical grid conflict risk;
correspondingly, the step of determining the risk level of the designated ship according to the real-time collision risk comprises:
determining the risk level of the designated ship according to the real-time collision risk and the historical grid conflict risk.

18. The computer-readable storage medium of claim 17, wherein the computer program, when executed by a processor, further implements, after determining the historical conflict risk of the area grid corresponding to the position where the designated ship is located as a historical grid conflict risk, the steps of:
acquiring probability of a ship collision accident in the area grid corresponding to the position where the designated ship is located;
adjusting the historical grid conflict risk according to the probability;
correspondingly, the step of determining the risk level of the designated ship according to the real-time collision risk and the historical grid conflict risk comprises:
determining the risk level of the designated ship according to the real-time collision risk and the adjusted historical grid conflict risk.

19. The computer-readable storage medium of claim 17, wherein the step, executed by the processor, of acquiring the historical conflict risk of each of the area grids through the adaptive collision risk assessment model comprises:
calculating the largest collision risk value of each pair of navigation trajectories within the water area where the designated ship is located through the adaptive collision risk assessment model;
determining two target trajectory points in each pair of navigation trajectories, wherein the two target trajectory points are two trajectory points corresponding to the largest collision risk value of one pair of navigation trajectories;
accumulating the largest collision risk values corresponding to the target trajectory points within the area grid for each of the area grids to acquire the historical collision risk of the area grid.

20. The computer-readable storage medium of claim 17, wherein the computer program, when executed by a processor, further implements, after acquiring the historical conflict risk of each of the area grids through the adaptive collision risk assessment model, the steps of:
marking a virtual sea chart of the water area according to the historical conflict risk of each of the area grids;
outputting the marked virtual sea chart to the designated ship.
